(19) United States
(12) Patent Application Publication
(10) Pub. No.: US 2012/0275653 A1
(43) Pub. Date: Nov. 1, 2012

(54) METHOD FOR RECOGNIZING LICENSE PLATE IMAGE, AND RELATED COMPUTER PROGRAM PRODUCT, COMPUTER-READABLE RECORDING MEDIUM, AND IMAGE RECOGNIZING APPARATUS USING THE SAME

(75) Inventors: Pei-Lun Hsieh, Taipei City (TW); Hong-Yuan Mark Liao, Taipei City (TW); Chung-Chia Kang, Tainan City (TW); Ho-Hsin Lee, Hsinchu City (TW); Chih-Wei Chen, New Taipei City (TW); Jian-Ren Chen, Hsinchu County (TW); Yi-Fei Luo, Hsinchu County (TW)

(73) Assignee: INDUSTRIAL TECHNOLOGY RESEARCH INSTITUTE, Hsinchu (TW)

(21) Appl. No.: 13/095,925

(22) Filed: Apr. 28, 2011

(51) Int. Cl. G06K 9/00

(52) U.S. Cl. 382/105

(57) ABSTRACT

A computer implemented method for recognizing license plate image, and related computer product, computer-readable recording medium, and image recognizing apparatus using the same is provided. The method includes collecting a plurality of character template images and respectively homogenizing the character template images to generate a plurality of simulated character template images based on the license plate image. The method also includes respectively generating a plurality of similarity degrees corresponding to the simulated character template images by comparing the simulated character template images with the license plate image. The method further includes estimating at least one candidate character corresponding to the license plate image and at least one candidate character position corresponding to the at least one candidate character according to the similarity degrees corresponding to the simulated character template images. Accordingly, the method can effectively recognize license plate numbers in a license plate image.

### TECHNICAL FIELD

The disclosure relates to a computer implemented method for recognizing license plate image, and related computer product, computer-readable recording medium, and image recognizing apparatus using the same.

### BACKGROUND

In many cities, video camcorder systems monitor traffic movements and potential criminal activities. As a result, violations of traffic rules and illegal behaviors no longer go undetected. However, such systems are expensive to run, the resolution of most video camcorders mounted in road intersections or on buildings in key locations is very low. Moreover, as the video clips are recorded outdoors, weather conditions may have a serious effect on the quality of the images, so they are often blurred. Under these circumstances, recognizing the characters in a blurred license plate image becomes a very important issue in investigations of a crime scene.

In order to recognize the characters in license plate images, some pattern recognition-based approaches have been proposed. In these approaches, a license plate recognition procedure can be divided into three steps: (1) license plate detection, (2) character segmentation, and (3) character recognition. The accuracy of pattern recognition-based approaches depends to a large extent on the result of character segmentation. However, it is well known that appropriate segmentation of the characters in a license plate image is a very difficult task because they are usually blurred and slanted if they are captured by a video camcorder.

In recent years, super-resolution-based image reconstruction has been proposed as an alternative way to tackle the license plate recognition problem. Unlike conventional pattern recognition approaches that perform recognition directly on a grabbed image frame, a super-resolution-based approach first tries to improve the quality of the grabbed frame. In super-resolution-based approaches, the current trend is to super-resolve multiple low-resolution images to a high-resolution image. However, a license plate is usually captured when the vehicle is moving. Hence, images captured in different time instances may provide different perspectives because they were captured in different angles in the field of view. This makes the registration task even more difficult.

### SUMMARY

Accordingly, the present disclosure is directed to a computer implemented method for recognizing license plate image, and related computer product, computer-readable recording medium, and image recognizing apparatus using the same, which can effectively recognize license plate numbers in a license plate image.

According to an embodiment of the present disclosure, a computer implemented method of recognizing a license plate image is provided. The method includes collecting a plurality of character template images and respectively homogenizing the character template images to generate a plurality of simulated character template images based on the license plate image. The method also includes respectively generating a plurality of similarity degrees corresponding to the simulated character template images by comparing the simulated character template images with the license plate image. The method further includes estimating at least one candidate character corresponding to the license plate image and at least one candidate character position corresponding to the at least one candidate character according to the similarity degrees corresponding to the simulated character template images.

According to an embodiment of the present disclosure, an image recognizing apparatus for recognizing a license plate image is provided. The image recognizing apparatus includes a database, an image extracting unit, a template simulating unit and an operation processing unit. The database is configured for storing a plurality of character template images. The image extracting unit is configured for extracting the license plate image. The template simulating unit is configured for respectively homogenizing the character template images to generate a plurality of simulated character template images based on the license plate image. The operation processing unit is configured for comparing the simulated character template images with the license plate image to respectively generate a plurality of similarity degrees corresponding to the simulated character template images and estimating at least one candidate character corresponding to the license plate image and at least one candidate character position corresponding to the at least one candidate character according to the similarity degrees corresponding to the simulated character template images.

According to an exemplary embodiment of the present disclosure, a computer program product is provided. The computer program product includes a plurality of program instructions, and the program instructions are suitable for being loaded into a computer system to execute the aforementioned method of recognizing a license plate image.

According to an exemplary embodiment of the present disclosure, a computer-readable recording medium for recording a program is provided, wherein the program executes the aforementioned method of recognizing a license plate image when the program is loaded into a computer system and executed by the same.

In order to make the aforementioned and other features of the present disclosure more comprehensible, several embodiments accompanied with figures are described in detail below.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a block diagram illustrating an image processing system equipped with an image recognizing apparatus according to an exemplary embodiment of the disclosure.

FIG. 2 is a diagram of extracting a license plate image by selecting four corners of a license plate in an image.

FIG. 3 is a diagram of extracting a license plate image by selecting two diagonal corners of a license plate in an image.

FIG. 4 illustrates an example of generating an inverse coordinate transformation matrix based on a license plate image to be recognized.

FIG. 5 illustrates an exemplary embodiment of the image processing system with an additional camera calibration unit.

FIG. 6 illustrates an exemplary embodiment of the image processing system with an additional 3D scene model reconstruction unit.

FIG. 7 illustrates an example of normalizing a gray level of the character template images.

FIG. 8 illustrates an example of generating the similarity degrees corresponding to the simulated character template images.

FIG. 9 illustrates an example of estimating candidate characters corresponding to the target license plate image and candidate character positions corresponding to the candidate characters according to the result shown in FIG. 8.

FIG. 10 illustrates a hierarchical structure of using multiple-character template images to recognize a target license plate image, which is applied for recognizing a Taiwanese license plate image.

FIG. 11 illustrates an example of using multiple-character template images to recognize a target license plate image.

FIG. 12 is a flowchart of a computer implemented method of recognizing a license plate image according to an exemplary embodiment of the disclosure.

### DESCRIPTION OF EMBODIMENTS

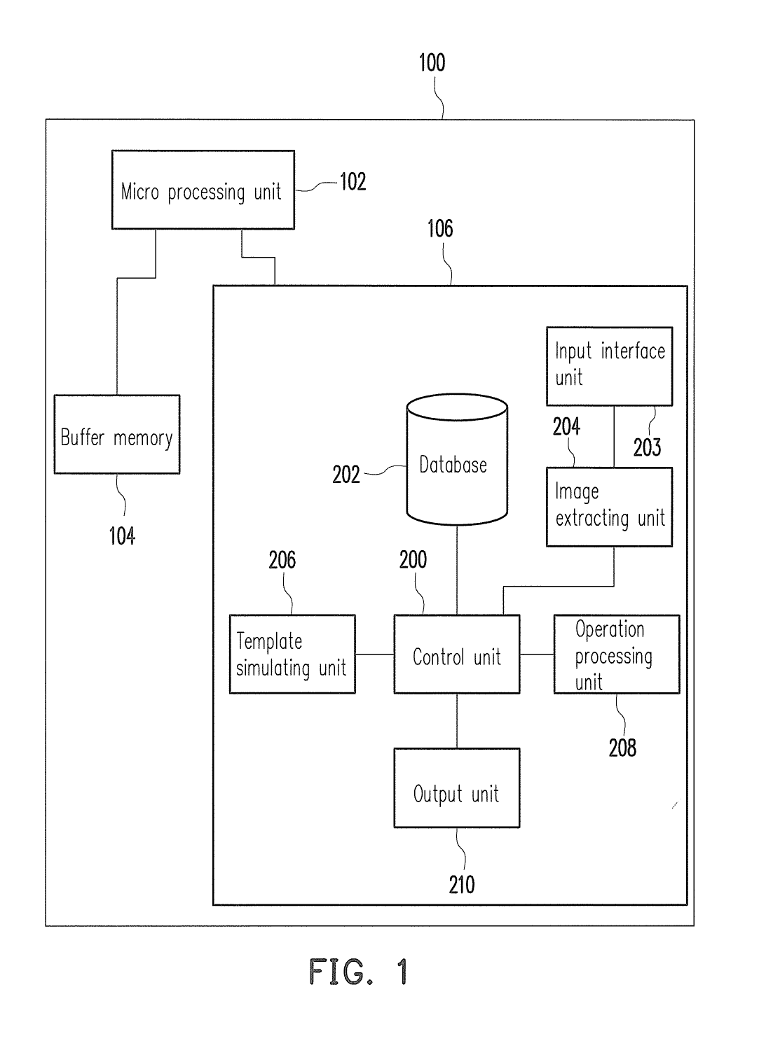

FIG. 1 is a block diagram illustrating an image processing system equipped with an image recognizing apparatus according to an exemplary embodiment of the disclosure.

Referring to FIG. 1, an image processing system 100 includes a micro processing unit 102, a buffer memory 104 and an image recognizing apparatus 106.

The micro processing unit 102 is configured for controlling a whole operation of the image processing system 100. For example, the micro processing unit 102 may give instructions to the image recognizing apparatus 106 for recognizing a license plate image.

The buffer memory 104 is coupled to the micro processing unit 102 and is configured for temporarily storing data. In the present exemplary embodiment, the buffer memory 104 is a static random-access memory (SRAM), though the disclosure is not limited thereto, and in another exemplary embodiment, the buffer memory 104 can also be a dynamic random access memory or other memories.

The image recognizing apparatus 106 is coupled to the micro processing unit 102 and is configured for recognizing a license plate image. To be specific, the image recognizing apparatus 106 may recognize a license plate image, which is blurred or has a low-resolution, and output possible license plate numbers corresponding to the license plate image.

The image recognizing apparatus 106 includes a control unit 200, a database 202, an input interface unit 203, an image extracting unit 204, a template simulating unit 206, an operation processing unit 208 and an output unit 210.

The control unit 200 is configured for controlling a whole operation of the image recognizing apparatus 106.

The database 202 is coupled to the control unit 200 and configured for storing a plurality of character template images. To be specific, license plate numbers of license plates are composed of a plurality of characters. For example, in Taiwan, these characters include the letters (from A to Z) and the digits (from 0 to 9). Herein, these character template images are images of these characters. For example, these character template images are extracted and collected from a plurality of high-resolution license plate images.

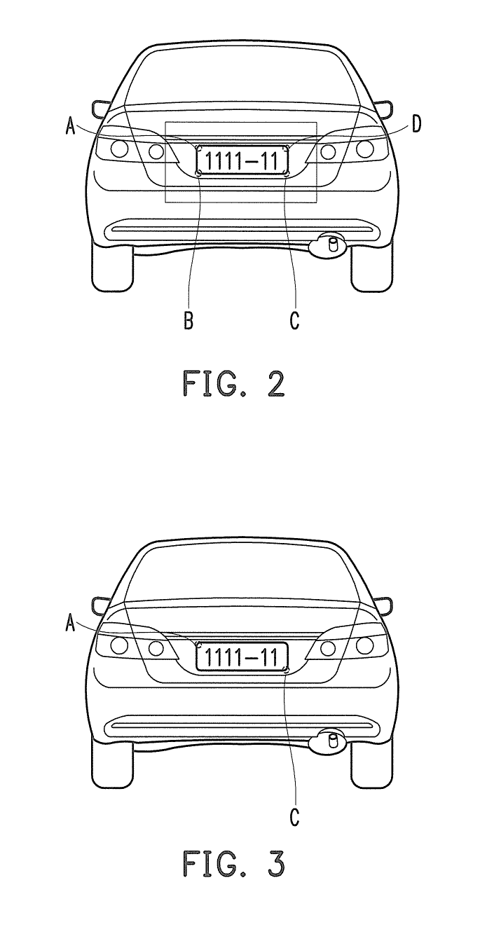

The image extracting unit 204 is coupled to the control unit 200 and configured for extracting a license plate image to be recognized (hereinafter referred to as “a target license plate image”) in an image. To be specific, a license plate to be recognized is usually shown in an image captured by a video camcorder. Therefore, before recognizing a license plate shown in an image, it requires extracting a license plate image from the image. For example, in the exemplary embodiment, the image recognizing apparatus 106 includes an input interface unit 203 for selecting four corners (as points A˜D shown in FIG. 2) of a license plate in an image by a user and the image extracting unit 204 extracts a target license plate image in the image according to the selected four corners. However, it should be understood that the disclosure is not limited to the above example, and in another exemplary embodiment of the disclosure, the input interface unit 203 for selecting two diagonal corners (as points A and C shown in FIG. 3) of a license plate in an image by a user and the image extracting unit 204 extracts a target license plate image in the image according to the selected two corners.

The template simulating unit 206 is coupled to the control unit 200 and configured for respectively homogenizing the character template images stored in the database 202 to generate a plurality of simulated character template images based on a target license plate image extracted by the image extracting unit 204. To be specific, in the present exemplary embodiment, the template simulating unit 206 may transform the character template images stored in the database 202 into a plurality of simulated character template images having the same characteristic as the target license plate image.

In the present exemplary embodiment, the template simulating unit 206 normalizes the size of each of the character template images. In particular, the template simulating unit 206 generates an inverse coordinate transformation matrix based on the target license plate image and normalizes the size of each of the character template images according to the inverse coordinate transformation matrix.

For example, in the present exemplary embodiment, the template simulating unit 206 identifies a plurality of symmetrical parts on a vehicle image in the image and rectifies the image to generate a rectified image. Then, the template simulating unit 206 uses original positions of the symmetrical parts in the image and new positions of the symmetrical parts in the rectified image to calculate a coordinate transformation matrix from the image to the rectified image, and thereby calculates the inverse coordinate transformation matrix according to the coordinate transformation matrix.

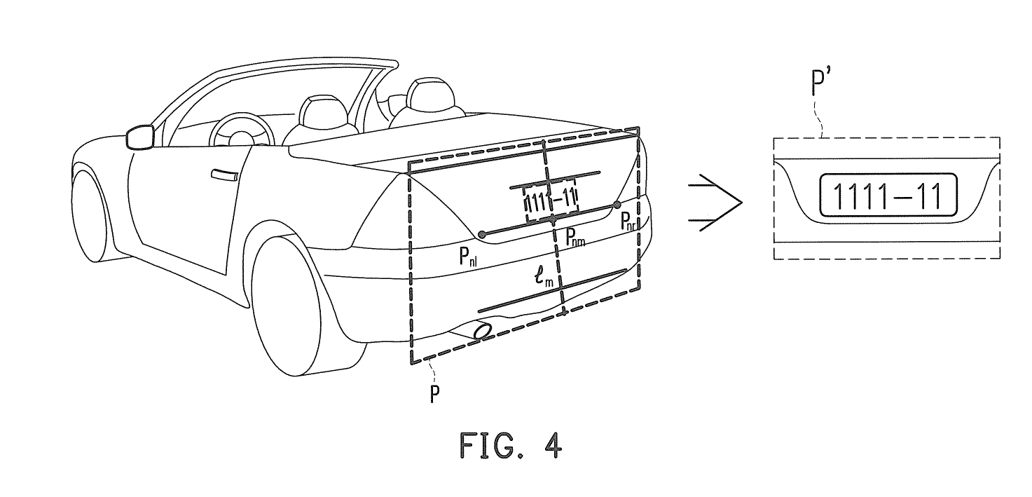

FIG. 4 illustrates an example of generating an inverse coordinate transformation matrix based on a license plate image to be recognized.

Referring to FIG. 4, the back region of a vehicle is distorted in a target image. In the present exemplary embodiment, the input interface unit 203 is configured for drawing a few line segments along the horizontal lines linking some symmetrical parts on the vehicle's back, as the four solid line segments drawn in FIG. 4 and the template simulating unit 206 identifies these symmetrical parts in a target image. Then, the template simulating unit 206 rectifies the target image to generate a rectified image based on these symmetrical parts. A rectifying algorithm according to the present exemplary embodiment will be described below, but the present disclosure is not limited thereto.

In the rectifying algorithm, first, we let lₙ be the n^{th} line segment drawn on the distorted image plane P, and Pₙₗ, Pₙᵣ and Pₙₘ be its left end point, right end point, and mid-point, respectively, as indicated in FIG. 4. Since the line segments are extracted by linking symmetrical parts of a vehicle's back, we can fit a straight mid-line lₘ to the midpoints. After rectification, we would like to transform line lₘ into the y-axis of the rectified plane P′, and the projection of P_{nm to l}ₘ as the new y-axis position of all points on each l′ₙ. As for the x-axis coordinate, we let the new mid-point P′ₙₘ have the same x-axis position as the distance from Pₙₘ to lₘ. Then, the x-axis position of the new end points, P′ₙₗ and P′ₙᵣ, are respectively set as the distance from Pₙₗ and Pₙᵣ to Pₙₘ. By using the above arrangement, we can further find a directional transformation matrix Mp between the distorted image plane P and the rectified plane P′ by using the corresponding end points of lₙ and l′ₙ as control points. The directional transformation relationship between control points can be expressed by a formula (1):

$${P}^{′} = ( \begin{matrix}{x}^{′} \\ {y}^{′} \\ 1\end{matrix} ) = ( \begin{matrix}{m}_{11} & {m}_{12} & {m}_{13} \\ {m}_{21} & {m}_{21} & {m}_{23} \\ {m}_{31} & {m}_{32} & {m}_{33}\end{matrix} ) * ( \begin{matrix}x \\ y \\ 1\end{matrix} ) = {M}_{p} * P \qquad ( 1 )$$

where P(x, y) is a point on the distorted image plane P and P′(x′, y′) is the transformed point on the rectified plane P′. Then, we can find the directional transformation matrix Mp by solving the following over-determined system:

$$( \begin{matrix}{x}_{1} & {y}_{1} & 1 & 0 & 0 & 0 & 0 & 0 \\ 0 & 0 & 0 & {x}_{1} & {y}_{1} & 1 & 0 & 0 \\ 0 & 0 & 0 & 0 & 0 & 0 & {x}_{1} & {y}_{1} \\ {x}_{2} & {y}_{2} & 1 & 0 & 0 & 0 & 0 & 0 \\ 0 & 0 & 0 & {x}_{2} & {y}_{2} & 1 & 0 & 0 \\ 0 & 0 & 0 & 0 & 0 & 0 & {x}_{2} & {y}_{2} \\ ⋮ & ⋮ & ⋮ & ⋮ & ⋮ & ⋮ & ⋮ & ⋮ \\ {x}_{n} & {y}_{n} & 1 & 0 & 0 & 0 & 0 & 0 \\ 0 & 0 & 0 & {x}_{n} & {y}_{n} & 1 & 0 & 0 \\ 0 & 0 & 0 & 0 & 0 & 0 & {x}_{n} & {y}_{n}\end{matrix} ) ( \begin{matrix}{m}_{11} \\ {m}_{12} \\ {m}_{13} \\ {m}_{21} \\ {m}_{22} \\ {m}_{23} \\ {m}_{31} \\ {m}_{32}\end{matrix} ) = ( \begin{matrix}{x}_{1}^{′} \\ {y}_{1}^{′} \\ 0 \\ {x}_{2}^{′} \\ {y}_{2}^{′} \\ 0 \\ ⋮ \\ {x}_{n}^{′} \\ {y}_{n}^{′} \\ 0\end{matrix} ) ≡ {A}_{m} = b \qquad ( 2 )$$

where (xₙ, yₙ) and (x′ₙ, y′ₙ) denote the positions of the n^{th} corresponding control points. This system can be solved by minimizing the error:

E(m)=(Am−b)² (3)

by

$$0 = \frac{\partial E}{\partial m} = 2 ( {A}^{T} {A}_{m} - {A}^{T} b ) \to {A}^{T} {A}_{m} = {A}^{T} b \qquad ( 4 )$$

where A^{T} denotes the transpose of A. By calculating each element of m, we can find the directional transformation matrix Mp to rectify the distorted image from the distorted image plane P to the rectified plane P′.

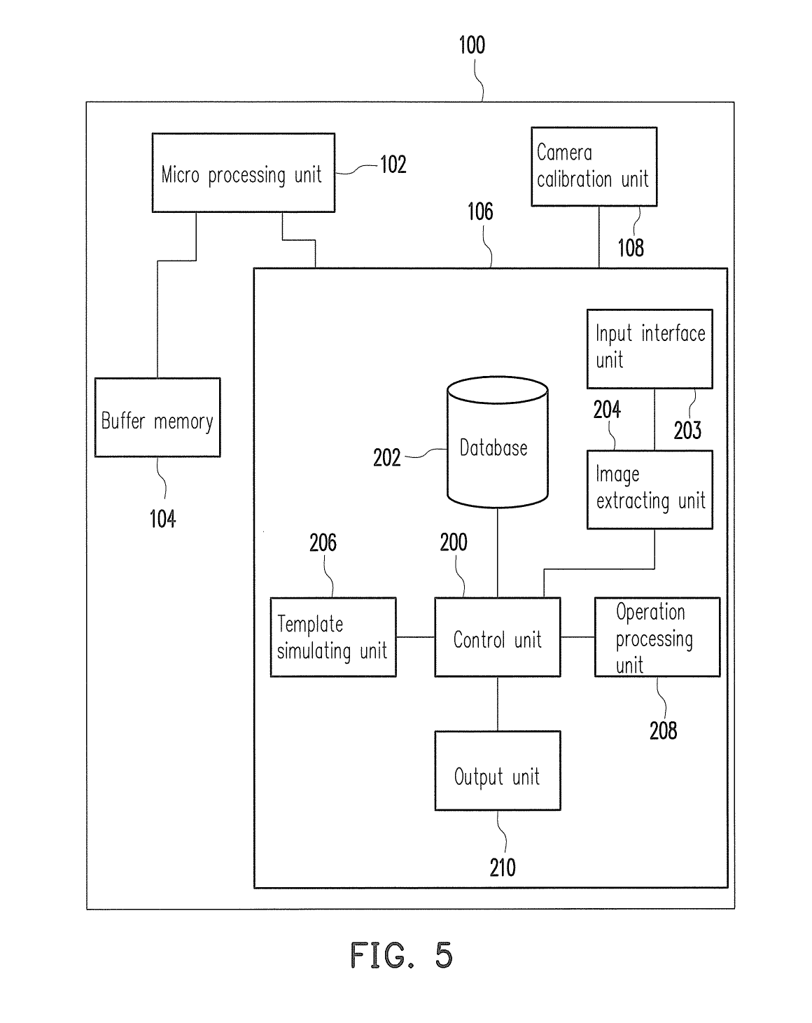

The directional transformation matrix Mp can be also obtained from a camera calibration unit 108 in FIG. 5. The camera calibration unit 108 is configured to calculate the angle between camera shooting direction and vehicle moving direction based on the camera posture parameters and vehicle moving direction information in the image, and compute the transformation matrix Mp to rectify the distorted image from the distorted image plane to the rectified plane.

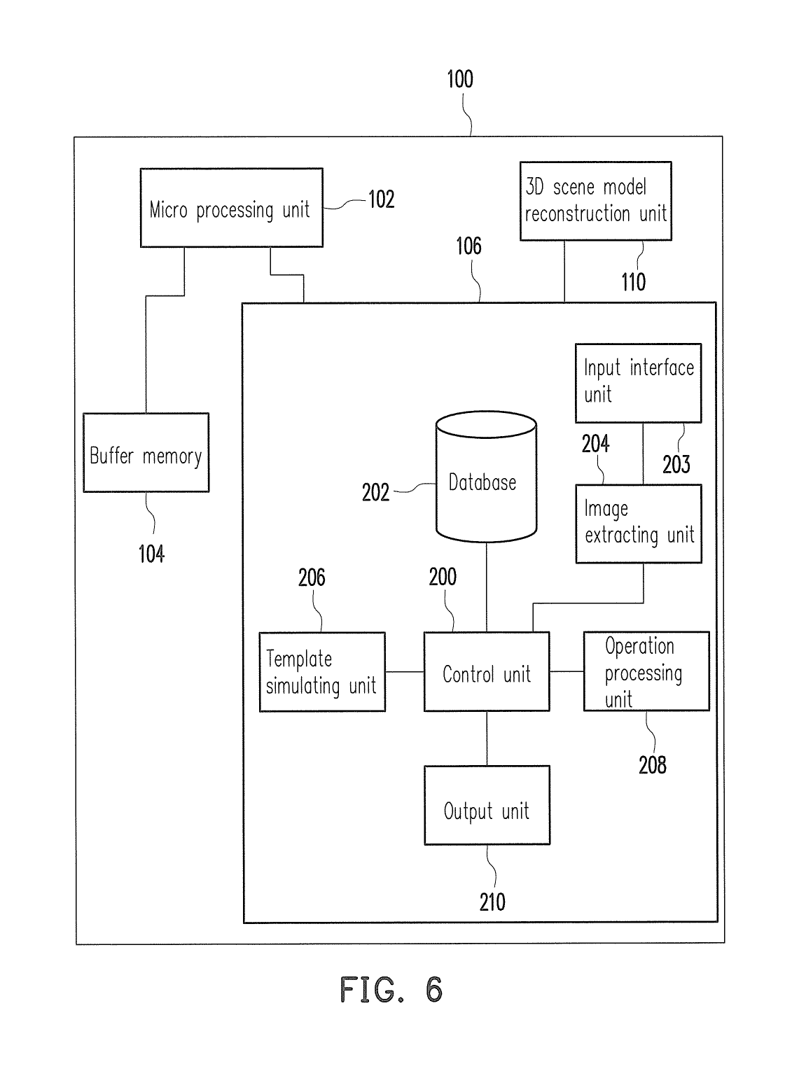

In another exemplary embodiment, the directional transformation matrix can be obtained from a 3D scene model reconstruction unit 110 in FIG. 6. By applying the same techniques cited in “3D scene reconstruction system with hand-held stereo cameras” by S. Yun, D. Min, and K. Sohn in the Proceedings of 2007 IEEE 3DTV Conference, “Reconstruction of 3d planes with an image-enhanced estimator” by S. Kristensen and H. I. Christensen in the Proceedings of 1994 International Workshop on Intelligent Robotic Systems and “Reconstruction of scene models from sparse 3D structure” by A. Manessis, A. Hilton, P. Palmer, P. McLauchlan, and X. Shen in the Proceedings of 2000 IEEE Conference on Computer Vision and Pattern Recognition, which are incorporated by reference herein and made a part of specification, one can reconstruct the 3D model in the image without using camera calibration. The transformation matrix Mp can thus be computed to rectify the distorted image from the distorted image plane to the rectified plane.

Besides calculating the directional transformation matrix Mp, in the rectifying algorithm, a scaling transformation matrix Ms is calculated for normalize the size of the target license plate image. Herein, the scaling transformation matrix Ms may be computed by a formula (5):

$${M}_{s} = ( \begin{matrix}\frac{{w}_{n}}{w} & 0 & 0 \\ 0 & \frac{{h}_{n}}{h} & 0 \\ 0 & 0 & 1\end{matrix} ) \qquad ( 5 )$$

where w and h are the width and height of the character region on the rectified plane P′, and wₙ and hₙ are the normalized width and height. Herein, the two transformation matrices can be combined into the coordinate transformation matrix M from the distorted image plane P to the rectified plane P′ as a formula (6):

M=Ms*Mp (6)

Accordingly, the template simulating unit 206 may generate the inverse coordinate transformation matrix M⁻¹ according to the coordinate transformation matrix M.

Besides normalizing the size of each of the character template images, in the present exemplary embodiment, the template simulating unit 206 further normalizes the image quality of each of the character template images, such that each of the generated simulated character template images has the same image quality as the target license plate image.

For example, in the present exemplary embodiment, the template simulating unit 206 identifies a mean and a standard deviation of a gray level of the target license plate image and normalizes a gray level of each of the character template images based on a formula (7):

$${T}_{c} = ( x , y ) = ( {I}_{c} ( x , y ) - {μ}_{{I}_{c}} ) * \frac{{δ}_{{I}_{t}}}{{δ}_{{I}_{c}}} + {μ}_{{I}_{t}} \qquad ( 7 )$$

where T_{c} is the normalized character template images, C is the set of all character template images; Iₜ is the target license plate image; μ_{It} and δ_{It} are respectively the mean and standard deviation of all pixel intensities in the target license plate image; μ_{Ic} and δ_{Ic} are respectively the mean and standard deviation of all pixel intensities in each of the character template images.

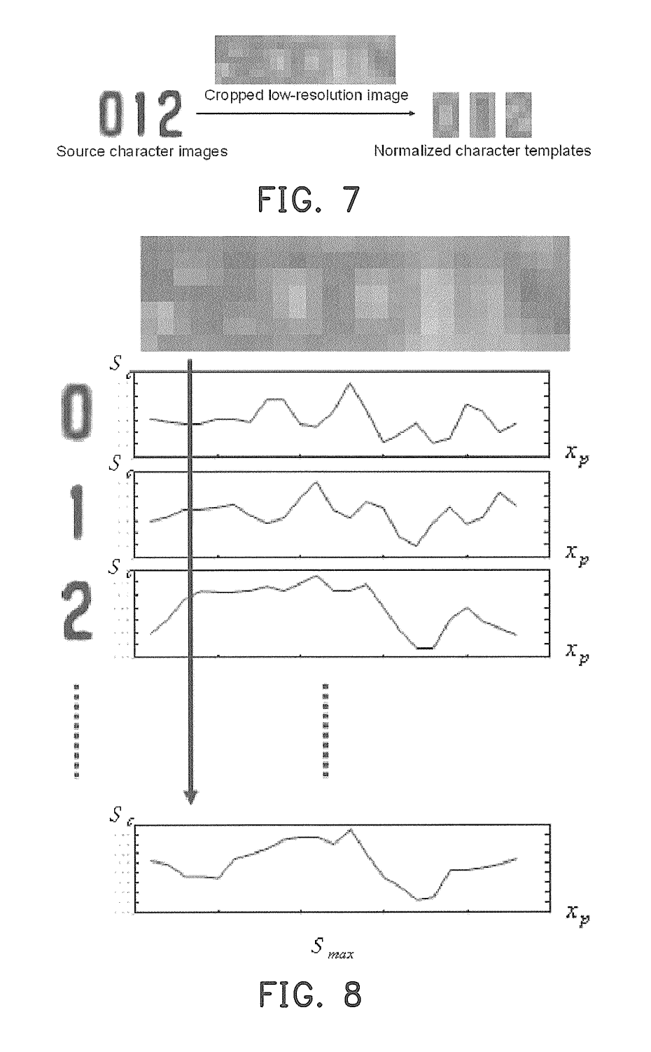

FIG. 7 illustrates an example of normalizing a gray level of the character template images.

Referring FIG. 7, the template simulating unit 206 identifies a mean and a standard deviation of a gray level of a cropped low-resolution image (i.e., a target license plate image) and respectively normalizing gray levels of character template images (e.g., from ‘0’ to ‘9’ and ‘A’ to ‘Z’) to generate normalized character template images based on the formula (7).

Consequently, according to the inverse coordinate transformation matrix M⁻¹ and the formula (7), the template simulating unit 206 may transform the character template images stored in the database 202 into the simulated character template images having the same size and gray level as the target license plate image.

Referring to FIG. 1 again, the operation processing unit 208 is coupled to the control unit 200 and configured for comparing the simulated character template images with the target license plate image to respectively generate the similarity degrees corresponding to the simulated character template images and estimates candidate characters corresponding to the target license plate image and candidate character positions corresponding to the candidate characters according to the similarity degrees corresponding to the simulated character template images.

For example, in the present exemplary embodiment, the operation processing unit 208 figures out the similarity degrees by sliding each of the simulated character template images on the target license plate image. The left bottom, left top, right bottom, right top, or middle of the simulated character template image can be served as the reference point of the sliding. For example, in the present exemplary embodiment, the reference point is at left bottom. Therefore, the simulated character template image is moved along the x-axis of the target license plate image one pixel to the right each time. The distances of all the pixels between simulated character template image and the corresponding target license plate image are averaged. The inverse of the average distance is recorded as the similarity degree S_{c} at each start position, which is the corresponding position of the reference point, of the target license plate image. The similarity curve of each simulated character template image is thus formed by connecting all the similarity degrees in the start positions. The similarity degree between the simulated character template image and the target license plate image during the sliding process can be measured by the inverse of L1-distance or L2-distance.

FIG. 8 illustrates an example of generating the similarity degrees corresponding to the simulated character template images.

Referring FIG. 8, the operation processing unit 208 uses each of the simulated character template images as a sliding window to search for all potential positions of the character in a target license plate image. In particular, when sliding a specific simulated character template image along the x-axis of a license plate image, the operation processing unit 208 calculates similarity degrees between the specific simulated character template image and all sub-images of the target license plate image for each x-axis point, and forms a similarity curve corresponding to the specific simulated character template image. Herein, the similarity degrees between the simulated character template images and the sub-images they cover during the sliding process are measured by the inverse of L1-distance as a formula (8):

$${S}_{c} ( {x}_{p} ) = {( \frac{1}{MN} {\sum }_{x = 0}^{M - 1} {\sum }_{y = 0}^{N - 1} \vert {T}_{c} ( x , y ) - {I}_{t} ( {x}_{p} + x , y ) \vert )}^{- 1} , c ∈ C \qquad ( 8 )$$

where the size of each of the simulated character template images is M*N, and xₚ represents the start position on the x-axis of a sub-image in the target license plate image.

After generating similarity curves corresponding to all of the simulated character template images, the operation processing unit 208 obtains the maximum similarity curve by choosing the maximum similarity degree among the similarity degrees in all xₚ positions by a formula (9):

$${S}_{max} ( {x}_{p} ) = {max}_{c ∈ C} {S}_{c} ( {x}_{p} ) \qquad ( 9 )$$

The bottom of FIG. 8 shows a scaled up version of the derived maximum similarity curve of the target license plate image. In the present exemplary embodiment, the operation processing unit 208 finds the local maxima along the maximum similarity curve, and accordingly estimates candidate characters and candidate character positions corresponding to the candidate characters. To be specific, every point on the maximum similarity curve means the most similar simulated character template image in that starting point, and therefore their positions should correspond to the candidate character positions.

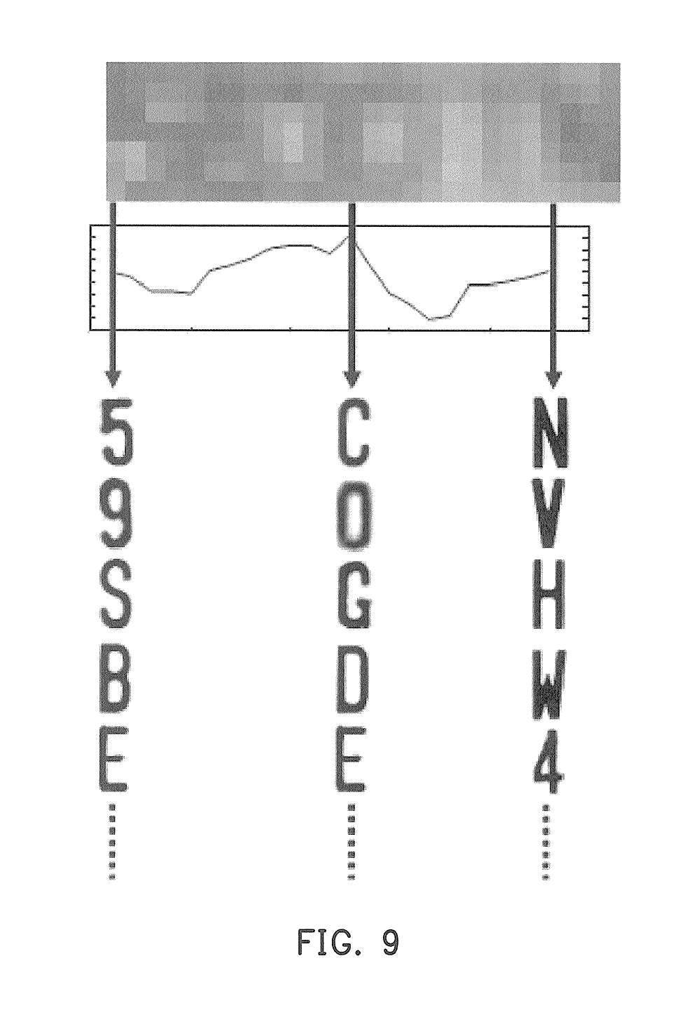

FIG. 9 illustrates an example of estimating candidate characters corresponding to the target license plate image and candidate character positions corresponding to the candidate characters according the result shown in FIG. 8.

Referring to FIG. 9, the operation processing unit 208 finds the local maxima along the maximum similarity curve and determines candidate character positions based on a formula (10):

X_{cand}={x_{cand}|Sₘₐₓ(x)≦Sₘₐₓ(x_{cand}), where|x_{cand}−x|<M/2} (10)

where M denotes the width of a simulated character template image.

Additionally, the operation processing unit 208 identifies corresponding candidate characters with the maximum similarity degree for each candidate character position X_{cand}. In the exemplary embodiment, the operation processing unit 208 takes the closest several characters according to a cutoff threshold for screening out qualified candidate characters with lower similarity degrees. For example, the operation processing unit 208 calculates the average of all the obtained similarity degrees and uses it as the cutoff threshold. However, it should be noted that the present disclosure is not limited thereof, and in another exemplary embodiment, the cutoff threshold can be predetermined as a fixed value. For example, the cutoff threshold may be set as 0.5.

In the present exemplary embodiment, the operation processing unit 208 further uses multiple-character template images based on the estimated candidate characters and the estimated corresponding candidate character positions to recognize a target license plate image and thereby estimates possible characters and possible character positions corresponding to the possible characters.

To be specific, the operation processing unit 208 combines the character template images to generate a plurality of multiple-character template images based on the estimated candidate characters and the corresponding candidate character positions. Then, the template simulating unit 206 homogenizes the multiple-character template images to generate a plurality of simulated multiple-character template images based on the license plate image. After that, the operation processing unit 208 respectively generates a plurality of similarity degrees corresponding to the simulated multiple-character template images by comparing the simulated multiple-character template images with the target license plate image and estimates a plurality of possible characters and a plurality of possible character positions corresponding to the possible characters according to the similarity degrees corresponding to the simulated multiple-character template images.

Herein, the homogenizing of the multiple-character template images, the generating of the similarity degrees corresponding to multiple-character template images and the estimating of possible characters and possible character positions are similar to that of the character template images, as shown in FIG. 4˜9, and therefore the details are not described herein.

It should be mentioned that, a specific symbol (e.g., a hyphen) is usually used in a license plate. Therefore, when using multiple-character template images to recognize a target license plate image, the specific symbol must be considered. For example, in a Taiwanese license plate, the hyphen may be on the right-hand side between the second and third characters or between the forth and fifth characters. For example, in the present exemplary embodiment, the input interface unit 203 which is capable of providing a user for selecting a type of a target license plate image, thereby recognizing a position of the specific symbol. Or, in another exemplary embodiment, it is hypothesized that a specific symbol may be located on the right-hand side between the second and third characters or between the forth and fifth characters, and the actual position can be recognized by sorting the similarity degrees. Moreover, in another exemplary embodiment, a character template image corresponding to the specific symbol is used for performing the foregoing homogenizing and comparing, thereby recognizing a specific symbol on the target license plate image.

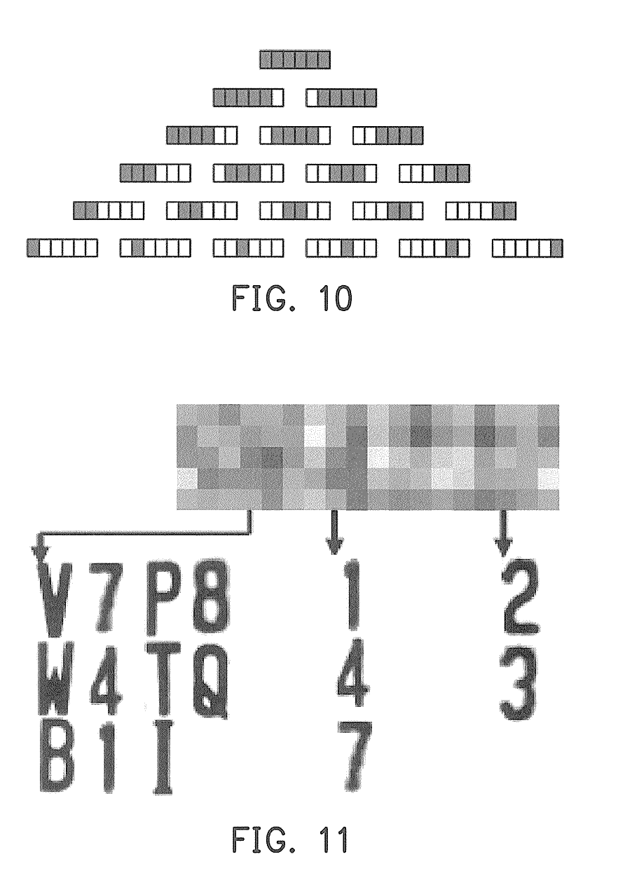

FIG. 10 illustrates a hierarchical structure of using multiple-character template images to recognize a target license plate image, which is applied for recognizing a Taiwanese license plate image.

Referring to FIG. 10, since Taiwanese license plate numbers have six characters, the bottom level shows six nodes that correspond to the six possible character positions. The second level from the bottom shows all possible combinations of two-character templates, the third level shows four possible three-character templates. To be specific, during the estimating for possible characters, candidate characters at neighbor positions in a higher level are estimated according to the candidate characters and their corresponding positions estimated in a lower level.

FIG. 11 illustrates an example of using multiple-character template images to recognize a target license plate image, wherein three candidate character positions detected by single-character templates and the list of candidate characters associated with each candidate character position (the 2^{nd}, 3^{rd} and 6^{th} positions from left to right) indicates an ordered list of candidate characters (from the top (most probable) to the bottom (least probable)).

Referring to FIG. 11, to extend the single-character template at the 2^{nd} position to the second level, the operation processing unit 208 combines character template images to generate all possible two-character template images for the 1^{st} and 2^{nd} positions. Since the character at the 1^{st} position is not identified by the single-character template, the operation processing unit 208 combines all 36 characters with the estimated candidate character corresponding to the 2^{nd} position. Additionally, the operation processing unit 208 combines character template images to generate all possible two-character template images for the 2^{nd} and 3^{rd} positions. Since the character at the 3^{rd} position is identified by the single-character template, the operation processing unit 208 combines the estimated candidate character corresponding to the 2^{nd} position with the estimated candidate character corresponding to the 3^{rd} position.

The template simulating unit 206 identifies the position of the hyphen on the target license plate image according to the methods described above and accordingly generates simulated two-character template images corresponding to the two-character template images.

The operation processing unit 208 compares the simulated two-character template images corresponding to the 1^{st} and 2^{nd} positions with the sub-images corresponding to the 1^{st} and 2^{nd} positions of the target license plate image, and calculates a similarity degree between each of these simulated two-character template images and the sub-images corresponding to the 1^{st} and 2^{nd} positions of the target license plate image, thereby generating the similarity degrees corresponding to these simulated multiple-character template images and estimating candidate characters corresponding to the 1^{st} and 2^{nd} positions. The operation processing unit 208 then compares the simulated two-character template images corresponding to the 2^{nd} and 3^{rd} positions with the sub-images corresponding to the 2^{nd} and 3^{rd} positions of the target license plate image, and calculates a similarity degree between each of these simulated two-character template images and the sub-images corresponding to the 2^{nd} and 3^{rd} positions of the target license plate image, thereby generating the similarity degrees corresponding to these simulated multiple-character template images and estimating candidate characters corresponding to the 2^{nd} and 3^{rd} positions according to the generated similarity degrees. Similarly, the operation processing unit 208 computes the average of those similarity degrees and uses it as the cutoff threshold to screen out the character templates with lower similarity degrees as the candidate characters.

With the same manner, the operation processing unit 208 extends the single-character templates at the 3^{rd} and 6^{th} position to the second level. Accordingly, the operation processing unit 208 may use three-character template images, four-character template images, five-character template images and six-character template images to find out possible characters corresponding to all the positions of the target license plate image.

Referring to FIG. 1 again, the output unit 210 is coupled to the control unit 200 and configured for outputting possible license plate numbers corresponding to the target license plate image based on the possible characters and the possible character positions corresponding to the possible characters. For example, the output unit 210 outputs the possible license plate numbers on a display or a printer.

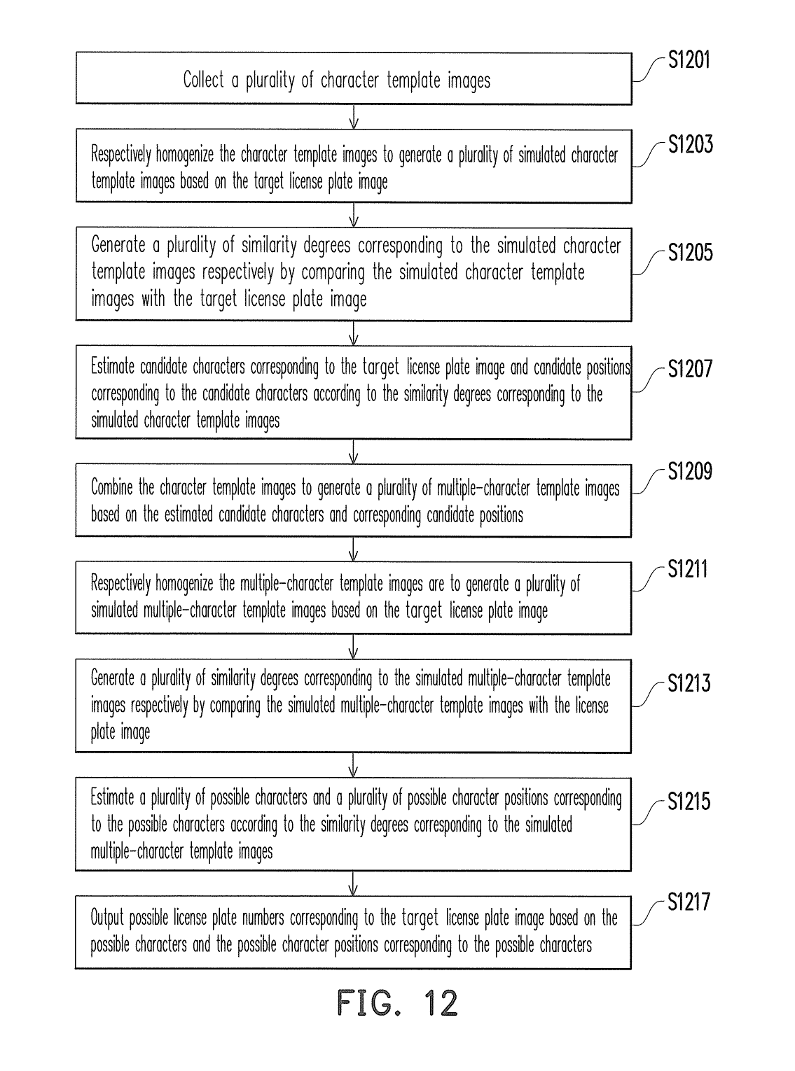

FIG. 12 is a flowchart of a computer implemented method of recognizing a license plate image (hereinafter “a target plate image”) according to an exemplary embodiment of the disclosure.

Referring to FIG. 12, in step S1201, a plurality of character template images are collected. For example, these character template images are extracted and collected from high-resolution license plate images.

In step S1203, the character template images are respectively homogenized to generate a plurality of simulated character template images based on the target license plate image. For example, as shown in FIGS. 4˜7 and described above, the character template images are normalized to generate the simulated character template images having the same size and the gray level of the target license plate images.

Then, in step S1205, a plurality of similarity degrees corresponding to the simulated character template images are generated respectively by comparing the simulated character template images with the target license plate image. Furthermore, in step S1207, candidate characters corresponding to the target license plate image and candidate character positions corresponding to the candidate characters are estimated according to the similarity degrees corresponding to the simulated character template images. The generating of the similarity degrees and the estimating of the candidate characters and corresponding candidate character positions have been described with FIGS. 8˜9 above therefore the details are omitted herein.

Then, in step S1209, the character template images are combined to generate a plurality of multiple-character template images based on the estimated candidate characters and corresponding candidate character positions. And, in step S1211, the multiple-character template images are respectively homogenized to generate a plurality of simulated multiple-character template images based on the target license plate image.

After that, in step S1213, a plurality of similarity degrees corresponding to the simulated multiple-character template images are generated respectively by comparing the simulated multiple-character template images with the license plate image. And, in step S1215, a plurality of possible characters and a plurality of possible character positions corresponding to the possible characters are estimated according to the similarity degrees corresponding to the simulated multiple-character template images. The detail steps for estimating possible characters and corresponding possible character positions by using multiple-character template images have been described with FIGS. 10˜11 above therefore the details are omitted herein.

Finally, in step S1217, possible license plate numbers corresponding to the target license plate image are output based on the possible characters and the possible character positions corresponding to the possible characters.

The present disclosure further provides a computer program product composed of a plurality of program instructions. The program instructions are suitable for being loaded into a computer system and executed by the same so as to perform the method of recognizing a license plate image described above and allow the computer system to have functions of the image recognizing apparatus described above.

In addition, the computer program product is stored in a computer-readable recording medium and subsequently read by a computer system, wherein the computer-readable recording medium may be any data storage medium. The computer-readable recording medium may be a read-only memory (ROM), a random-access memory (RAM), a CD-ROM, a magnetic tape, a floppy disc, or an optical data storage device.

In light of the foregoing, the method recognizing a license plate image and the image recognizing apparatus according to the present disclosure identify the positions of the characters on a license plate image and use simulated character template images to derive their corresponding character lists. Additionally, the method recognizing a license plate image and the image recognizing apparatus according to the present disclosure further identify the location of any special symbol, such as a hyphen. Furthermore, the method recognizing a license plate image and the image recognizing apparatus according to the present disclosure expand the character template images to multiple-character templates images to refine the recognition results. Accordingly, the method recognizing a license plate image and the image recognizing apparatus according to the present disclosure can effectively recognize characters in blurred license plate images without segmenting the characters.

It will be apparent to those skilled in the art that various modifications and variations can be made to the structure of the present disclosure without departing from the scope or spirit of the disclosure. In view of the foregoing, it is intended that the present disclosure cover modifications and variations of this invention provided they fall within the scope of the following claims and their equivalents.

What is claimed is:

1. A computer implemented method of recognizing a license plate image, comprising:
collecting a plurality of character template images;
respectively homogenizing the character template images to generate a plurality of simulated character template images based on the license plate image;
respectively generating a plurality of similarity degrees corresponding to the simulated character template images by comparing the simulated character template images with the license plate image;
estimating at least one candidate character corresponding to the license plate image and at least one candidate character position corresponding to the at least one candidate character according to the similarity degrees corresponding to the simulated character template images.

2. The computer implemented method as claimed in claim 1, further comprising:
combining the character template images to generate a plurality of multiple-character template images based on the at least one candidate character and the at least one candidate character position corresponding to the at least one candidate character;
respectively homogenizing the multiple-character template images to generate a plurality of simulated multiple-character template images based on the license plate image;
respectively generating a plurality of similarity degrees corresponding to the simulated multiple-character template images by comparing the simulated multiple-character template images with the license plate image;
estimating a plurality of possible characters and a plurality of possible character positions corresponding to the possible characters according to the similarity degrees corresponding to the simulated multiple-character template images; and
outputting at least one possible license plate number corresponding to the license plate image based on the possible characters and the possible character positions corresponding to the possible characters.

3. The computer implemented method as claimed in claim 1, further comprising:
generating an inverse coordinate transformation matrix corresponding to the license plate image; and
identifying an image quality of the license plate image,
wherein the step of respectively homogenizing the character template images to generate the simulated character template images based on the license plate image comprising:
respectively normalizing the character template images based on the inverse coordinate transformation matrix and the image quality of the license plate image to generate the simulated character template images.

4. The computer implemented method as claimed in claim 3, wherein the step of identifying the image quality corresponding to the license plate image comprises:
identifying a mean and a standard deviation of a gray level of the license plate image,
wherein the step of respectively normalizing the character template images based on the inverse coordinate transformation matrix and the image quality to generate the simulated character template images comprises:
normalizing a size of each of the character template images based on the inverse coordinate transformation matrix and normalizing a gray level of each of the character template images based on the mean and the standard deviation of the gray level of the license plate image to generate each of the simulated character template images.

5. The computer implemented method as claimed in claim 2, further comprising:
generating an inverse coordinate transformation matrix corresponding to the license plate image; and
identifying an image quality of the license plate image,
wherein the step of respectively homogenizing the multiple-character template images to generate a plurality of simulated multiple-character template images based on the license plate image comprising:
respectively normalizing the multiple-character template images based on the inverse coordinate transformation matrix and the image quality of the license plate image to generate the simulated multiple-character template images.

6. The computer implemented method as claimed in claim 3, further comprising:
extracting the license plate image from an image by selecting four corners of the license plate image in the image or selecting two diagonal corners of the license plate image in the image.

7. The computer implemented method as claimed in claim 5, wherein the step of generating the inverse coordinate transformation matrix corresponding to the license plate image comprises:
identifying a plurality of symmetrical parts on a vehicle image in the image;
rectifying the image to generate a rectified image;
calculating a coordinate transformation matrix between the image and the rectified image by using original positions of the symmetrical parts in the image and new positions of the symmetrical parts in the rectified image; and
calculating the inverse coordinate transformation matrix according to the coordinate transformation matrix.

8. The method as claimed in claim 1, wherein the step of respectively generating the similarity degrees corresponding to the simulated character template images by comparing the simulated character template images with the license plate image comprises:
calculating a distance between each of the simulated character template images and a corresponding position of the license plate image; and
respectively generating the similarity degrees corresponding to the simulated character template images based on the distances.

9. The method as claimed in claim 2, wherein the step of respectively generating similarity degrees corresponding to the simulated multiple-character template images by comparing the simulated multiple-character template images with the license plate image comprises:
sliding each of the simulated multiple-character template images on the license plate image and respectively calculating the similarity degrees corresponding to the simulated multiple-character template images.

10. The method as claimed in claim 1, further comprises:
identifying a specific symbol on the license plate image and a position of the specific symbol.

11. An image recognizing apparatus for recognizing a license plate image, comprising:
a database, configured for storing a plurality of character template images;
an image extracting unit, configured for extracting the license plate image;
a template simulating unit, configured for respectively homogenizing the character template images to generate a plurality of simulated character template images based on the license plate image; and
an operation processing unit, configured for comparing the simulated character template images with the license plate image to respectively generate a plurality of similarity degrees corresponding to the simulated character template images,
wherein the operation processing unit estimates at least one candidate character corresponding to the license plate image and at least one candidate character position corresponding to the at least one candidate character according to the similarity degrees corresponding to the simulated character template images.

12. The image recognizing apparatus as claimed in claim 11, further comprising an output unit,
wherein the operation processing unit combines the character template images to generate a plurality of multiple-character template images based on the at least one candidate character and the at least one candidate character position corresponding to the at least one candidate character,
wherein the template simulating unit respectively homogenizes the multiple-character template images to generate a plurality of simulated multiple-character template images based on the license plate image,
wherein the operation processing unit respectively generates a plurality of similarity degrees corresponding to the simulated multiple-character template images by comparing the simulated multiple-character template images with the license plate image,
wherein the operation processing unit estimates a plurality of possible characters and a plurality of possible character positions corresponding to the possible characters according to the similarity degrees corresponding to the simulated multiple-character template images, and
wherein the output unit is configured for outputting at least one possible license plate number corresponding to the license plate image based on the possible characters and the possible character positions corresponding to the possible characters.

13. The image recognizing apparatus as claimed in claim 11,
wherein the template simulating unit generates an inverse coordinate transformation matrix corresponding to the license plate image and identifies an image quality of the license plate image,
wherein the template simulating unit respectively normalizes the character template images based on the inverse coordinate transformation matrix and the image quality of the license plate image to generate the simulated character template images.

14. The image recognizing apparatus as claimed in claim 13, wherein the template simulating unit identifies a mean and a standard deviation of a gray level of the license plate image,
wherein the template simulating unit normalizes a size of each of the character template images based on the inverse coordinate transformation matrix and normalizes a gray level of each of the character template images based on the mean and the standard deviation of the gray level of the license plate image to generate each of the simulated character template images.

15. The image recognizing apparatus as claimed in claim 12, wherein the template simulating unit generates an inverse coordinate transformation matrix corresponding to the license plate image and identifies an image quality of the license plate image,
wherein the template simulating unit respectively normalizes the multiple-character template images based on the inverse coordinate transformation matrix and the image quality of the license plate image to generate the simulated multiple-character template images.

16. The image recognizing apparatus as claimed in claim 13, wherein the image extracting unit extracts the license plate image from an image according to four corners of the license plate image in the image or two diagonal corners of the license plate image in the image.

17. The image recognizing apparatus as claimed in claim 15, wherein the template simulating unit identifies a plurality of symmetrical parts on a vehicle image in the image and rectifies the image to generate a rectified image,
wherein the template simulating unit uses original positions of the symmetrical parts in the image and new positions of the symmetrical parts in the rectified image to calculate a coordinate transformation matrix between the image and the rectified image,
wherein the template simulating unit calculates the inverse coordinate transformation matrix according to the coordinate transformation matrix.

18. The image recognizing apparatus as claimed in claim 11, wherein the operation processing unit slides each of the simulated character template images on the license plate image, and respectively calculates the similarity degrees corresponding to each of the simulated character template images.

19. The image recognizing apparatus as claimed in claim 12, wherein the operation processing unit calculates a distance between each of the simulated character template images and a corresponding position of the license plate image, and respectively generating the similarity degrees corresponding to the simulated character template images based on the distances.

20. The image recognizing apparatus as claimed in claim 11, wherein the template simulating unit identifies a specific symbol on the license plate image and a position of the specific symbol.

21. The image recognizing apparatus as claimed in claim 11, wherein the license plate image is rectified by a camera calibration unit or a 3D scene model reconstruction unit.

22. A computer program product, comprising a plurality of program instructions, which when executed by a computer system, cause the computer system to execute the method according to claim 1.

23. A computer-readable recording medium having a program, which when executed by a computer system, cause the computer system to execute the method according to claim 1.
